(19) United States
(12) Patent Application Publication
(10) Pub. No.: US 2025/0300896 A1
(43) Pub. Date: Sep. 25, 2025

(54) METHODS, SYSTEMS, AND COMPUTER READABLE MEDIA FOR CONTROLLING PACKET SIZE STATISTICS IN GENERATING SIMULATED NETWORK TRAFFIC

(71) Applicant: Keysight Technologies, Inc., Santa Clara, CA (US)

(72) Inventor: Reza Soosahabi, Austin, TX (US)

(21) Appl. No.: 18/671,865

(22) Filed: May 22, 2024

Related U.S. Application Data
(60) Provisional application No. 63/568,902, filed on Mar. 22, 2024.

(51) Int. Cl. H04L 41/14

(52) U.S. Cl. CPC H04L 41/145

(57) ABSTRACT

A method for generating an application mix of network traffic with a desired packet size includes configuring a plurality of simulated network traffic generator components to generate a defined application mix of network traffic with different values of the packet size statistic. The defined application mix includes simulated applications and fixed network traffic allocations assigned to each of the simulated applications. The components are enabled, and the values of the packet size statistic are measured. The measured values are input into a model to calculate a throughput value for each component so that the aggregated traffic output from the components achieves a desired value of the packet size statistic. The components are enabled with the computed throughput values to send simulated application traffic to a DUT, where the traffic maintains the application mix and achieves the desired value of the packet size statistic.

### PRIORITY CLAIM

This application claims the priority benefit of U.S. Provisional Patent Application Ser. No. 63/568,902 filed Mar. 22, 2024, the disclosure of which is incorporated herein by reference in its entirety.

### TECHNICAL FIELD

The subject matter described herein relates to controlling packet size statistics in generating simulated network traffic. More particularly, the subject matter described herein relates to generating an application mix of simulated network traffic with a desired packet size statistic while maintaining traffic allocations assigned to the applications in the application mix.

### BACKGROUND

In network traffic simulations, it is desirable for simulated network traffic generators, i.e., the components that generate simulated network traffic, to control packet size statistics during the generation of the simulated network traffic. Controlling the packet size statistics may include controlling any suitable statistical measure of packet size, including average packet size, variance in packet size, and packet size distribution. For example, it may be desirable for one simulated network traffic generator component to generate packets with sizes within one range, e.g., 200 bytes to 300 bytes, and another simulated network traffic generator component to generate packets with sizes within a different range, e.g., 300 bytes to 400 bytes.

Simulated network traffic generators can be configured to generate application mixes of simulated network traffic, where an application mix is a mix of simulated network traffic for different applications, such as web browsing, social media, streaming video, etc., with different network traffic allocations, sometimes in the form of bandwidth percentages, assigned to the applications. For robust testing of network equipment, it is desirable to vary the packet sizes of the packets generated by the different simulated applications. One way to vary packet sizes in simulated application traffic is to change the traffic allocations assigned to the different simulated applications. However, more realistic testing may require the changing of packet sizes while maintaining the network traffic allocations assigned to the simulated applications. Accordingly, in light of these and other difficulties, there exists a need for improved methods, systems, and computer readable media for controlling a packet size statistic in generating simulated network traffic.

### SUMMARY

A method for generating an application mix of simulated network traffic with a desired packet size statistic while maintaining traffic allocations in the application mix includes configuring a plurality of simulated network traffic generator components to generate a defined application mix of network traffic with different values of the packet size statistic, where the defined application mix includes fixed network traffic allocations assigned to each of a plurality of simulated applications. The method further includes during a measurement phase, enabling the simulated network traffic generator components to generate the defined application mix of network traffic and measuring a throughput and a packet size statistic of each of the simulated network traffic generator components. The method further includes computing, using the measured throughputs, the measured packet size statistics, a desired value or distribution of values of the packet size statistic, and a model, a throughput value for each of the simulated network traffic generator components. The method further includes, during a test traffic generation phase, enabling each of the simulated network traffic generator components with the computed throughput values to generate the defined application mix of network traffic.

According to another aspect of the subject matter described herein, configuring the simulated network traffic generator components to generate the application mix of simulated network traffic includes configuring the simulated network traffic generator components with the same fixed network traffic allocation values for the same applications simulated by different ones of the simulated network traffic generator components.

According to another aspect of the subject matter described herein, configuring the simulated network traffic generator components to generate the defined application mix of network traffic with different values of the packet size statistic includes configuring open systems interconnect (OSI) layer 3, layer 4, and/or layer 7 parameters of the simulated network traffic generator components to generate the different values of the packet size statistic.

According to another aspect of the subject matter described herein, the packet size statistic comprises an average packet size and configuring the simulated network traffic generator components to generate the different values of the packet size statistic includes configuring a first simulated network traffic generator component to generate simulated network traffic with a first average packet size value and configuring a second simulated network traffic generator component to generate simulated network traffic with a second average packet size value, where the first average packet size value is greater than the second average packet size value.

According to another aspect of the subject matter described herein, computing the throughput values comprises computing:

$${Tput}_{hi} = \frac{{APS}_{hi} \times ( {APS}_{desired} - {APS}_{lo} )}{{APS}_{desired} \times ( {APS}_{hi} - {APS}_{lo} )} \times {Tput}_{total}$$

$${Tput}_{lo} = \frac{{APS}_{lo} \times ( {APS}_{h i} - {APS}_{desired} )}{{APS}_{desired} \times ( {APS}_{h i} - {APS}_{lo} )} \times {Tput}_{total} ,$$

where Tputₕᵢ is the throughput value calculated for the first simulated network traffic generator component, Tputₗₒ is the throughput value calculated for the second simulated network traffic generator component, APSₕᵢ is an average packet size value of the simulated network traffic generated by the first simulated network traffic generator component, APSₗₒ is the average packet size of the simulated network traffic generated by the second simulated network traffic generator component, APS_{desired} is a desired average packet size value, and Tputₜₒₜₐₗ is a total throughput of the first and second simulated network traffic generator components.

According to another aspect of the subject matter described herein, the packet size statistic is variance in packet size values.

According to another aspect of the subject matter described herein, the packet size statistic is a desired distribution of packet size values.

According to another aspect of the subject matter described herein, the model relates the desired packet size statistic value or distribution of values to a linear combination of values or distributions of values of the packet size statistic for simulated network traffic generated by the simulated network traffic generator components.

According to another aspect of the subject matter described herein, the model is defined by the following expression:

$$E ( f , {p}^{*} ) {=}^{Δ} {\sum }_{i = 1}^{N} {ϕ}_{i} \cdot E ( f , {p}_{i} ) ,$$

where E(f, p*) is an expected value of the packet size statistic for simulated network traffic generated by all of the simulated network traffic generator components, f is a feature function that produces the values of the packet size statistic, p* is probability distribution of values of the packet size statistic for the simulated network traffic generated by all of the simulated network traffic generator components, ϕᵢ is a network traffic weight assigned to an i^{th} simulated network traffic generator component, E(f, pᵢ) is an expected value of the packet size statistic for the i^{th} simulated network traffic generator component, and pᵢ is a probability distribution for values of the packet size statistic for the i^{th} simulated network traffic generator component.

According to another aspect of the subject matter described herein, the defined application mix of network traffic generated during the test traffic generation phase achieves a value or distribution of values of the packet size statistic that is equal to or substantially equal to the desired value or distribution of values of the packet size statistic while maintaining the fixed network traffic allocations assigned to the simulated applications.

According to another aspect of the subject matter described herein, system for generating an application mix of simulated network traffic with a desired packet size statistic while maintaining traffic allocations in the application mix is provided. The system includes a test computing platform including at least one processor and a memory. The system further includes a simulated network traffic generator component manager executable by the at least one processor for: configuring a plurality of simulated network traffic generator components to generate a defined application mix of network traffic with different values of the packet size statistic, where the defined application mix includes a fixed network traffic allocation assigned to each of a plurality of simulated applications; during a measurement phase, enabling the simulated network traffic generator components to generate the defined application mix of network traffic and measuring a throughput and a packet size statistic of each of the simulated network traffic generator components; computing, using the measured throughputs, the measured packet size statistics, a desired value or distribution of values of the packet size statistic, and a model, a throughput value for each of the simulated network traffic generator components; and during a test traffic generation phase, enabling each of the simulated network traffic generator components with the computed throughput values to generate the defined application mix of network traffic.

According to another aspect of the subject matter described herein, the simulated network traffic generator component manager configures the simulated network traffic generator components with the same fixed network traffic allocation values for the same applications simulated by different ones of the simulated network traffic generator components.

According to another aspect of the subject matter described herein, the simulated network traffic generator component manager configures the simulated network traffic generator components to achieve the different values of the packet size statistic by configuring open systems interconnect (OSI) layer 3, layer 4, and/or layer 7 parameters of the simulated network traffic generator components to generate the different values of the packet size statistic.

According to another aspect of the subject matter described herein, the packet size statistic comprises an average packet size and the simulated network traffic generator component manager configures a first simulated network traffic generator component to generate simulated network traffic with a first average packet size value and a second simulated network traffic generator component to generate simulated network traffic with a second average packet size value, where the first average packet size value is greater than the second average packet size value.

According to another aspect of the subject matter described herein, the simulated network traffic generator component manager is configured to compute the throughput values as follows:

$${Tput}_{h i} = \frac{{APS}_{h i} \times ( {APS}_{d e s i r e d} - {APS}_{l o} )}{{APS}_{d e s i r e d} \times ( {APS}_{h i} - {APS}_{l o} )} \times {Tput}_{total}$$

$${Tput}_{l o} = \frac{{APS}_{l o} \times ( {APS}_{h i} - {APS}_{d e s i r e d} )}{{APS}_{d e s i r e d} \times ( {APS}_{h i} - {APS}_{l o} )} \times {Tput}_{total} ,$$

where Tputₕᵢ is the throughput value calculated for the first simulated network traffic generator component, Tputᵢₒ is the throughput value calculated for the second simulated network traffic generator component, APSₕᵢ is an average packet size value of the simulated network traffic generated by the first simulated network traffic generator component, APSₗₒ is the average packet size of the simulated network traffic generated by the second simulated network traffic generator component, APS desired is a desired average packet size value, and Tputₜₒₜₐₗ is a total throughput of the first and second simulated network traffic generator components.

According to another aspect of the subject matter described herein, a non-transitory computer readable medium having stored thereon executable instructions that when executed by a processor of a computer control the computer to perform steps is provided. The steps include configuring a plurality of simulated network traffic generator components to generate a defined application mix of network traffic with different values of a packet size statistic, where the defined application mix includes a fixed network traffic allocation assigned to each of a plurality of simulated applications. The steps further include, during a measurement phase, enabling the simulated network traffic generator components to generate the defined application mix of network traffic and measuring a throughput and a packet size statistic of each of the simulated network traffic generator components. The steps further include computing, using the measured throughputs, the measured packet size statistics, a desired value or distribution of values of the packet size statistic, and a model, a throughput value for each of the simulated network traffic generator components. The steps further include, during a test traffic generation phase, enabling each of the simulated network traffic generator components with the computed throughput values to generate the defined application mix of network traffic.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a block diagram illustrating a plurality of simulated network traffic generator components that can be configured to produce a desired packet size statistic;

FIG. 2 is a block diagram illustrating a high packet size simulated network traffic generator component and a low packet size simulated network traffic generator component usable to generate simulated network traffic with a desired average packet size;

FIG. 3 is a block diagram illustrating an exemplary system for generating an application mix of simulated network traffic with a desired value or distribution of values of a packet size statistic while maintaining network traffic allocations for the applications in the application mix; and

FIG. 4 is a flow chart illustrating an exemplary process of for generating an application mix of network traffic with a desired value or distribution of values of a packet size statistic while maintaining network traffic allocations for the applications in the application mix.

### DETAILED DESCRIPTION

The subject matter described herein relates to simulated network traffic generation where the goal is to generate an application mix of simulated network traffic and vary a packet size statistic in the simulated network traffic while maintaining fixed bandwidth allocations assigned to the simulated network applications. For example, it may be desirable to create an application simulation test scenario that generates an application traffic mix (AppMix) of network traffic with fixed application weights (flow or bandwidth based), with a desired packet-size statistic. In another example, it may be desirable to maximize a range of possible packet-size statistics of packets generated during a test to evaluate the performance of a device under test (DUT) for a variety of packet-size statistics. The test should maintain the provided AppMix bandwidth allocations during the test. In yet another example, it may be desirable to control a simulated network traffic generator to maintain a desired packet size statistic by adaptively responding to traffic pattern alterations by the DUT.

One way to control average packet size in a simulated traffic scenario is to control the bandwidth allocated to the applications. However, network equipment manufacturers consider this method of controlling packet size as “cheating” or unrealistic in performing network testing. Table 1 shown below illustrates an example of an application mix of real network traffic and data bandwidth volumes consumed by traffic for each application.

TABLE 1
Top Apps by Downstream Volume 2023 (Europe)

| | % Downstream | |
|---|---|---|
| App Name | Volume | Sub. Volume (MB) |
| YouTube | 15 | 699 |
| Netflix | 15 | 682 |
| DAZN | 7 | 331 |
| Tik Tok | 6 | 289 |
| Facebook | 6 | 289 |
| Operator Content | 5 | 235 |
| PlayStation Downloads | 5 | 223 |
| Instagram | 5 | 221 |
| Disney | 4 | 181 |
| Amazon Prime | 4 | 176 |

Table 1 illustrates the top 10 applications by downstream volume for Internet traffic in Europe. It may be desirable to simulate this mix of network traffic with the defined traffic volumes (e.g., by percentage (as illustrated in column 2), or by traffic volume per subscriber (column 3)) and change the packet sizes of the simulated traffic during a test, while maintaining the traffic bandwidth allocations assigned to the simulated applications. In a simple example, if a test assigns a 15% bandwidth allocation to simulated YouTube traffic and a 15% bandwidth allocation to simulated Netflix traffic, it may be desirable to maintain the bandwidth percentages while changing the average packet sizes of the packets carrying the simulated YouTube traffic and the simulated Netflix traffic.

In addition to changing packet sizes while keeping bandwidth allocations to simulated applications the same, it may also be desirable to maximize the range of desired packet statistics to evaluate the performance of a DUT for varying packet size statistics. Another objective in generating simulated network traffic may be to adaptively respond to traffic pattern alterations by the DUT while maintaining desired packet size statistics.

### Model and Derivation

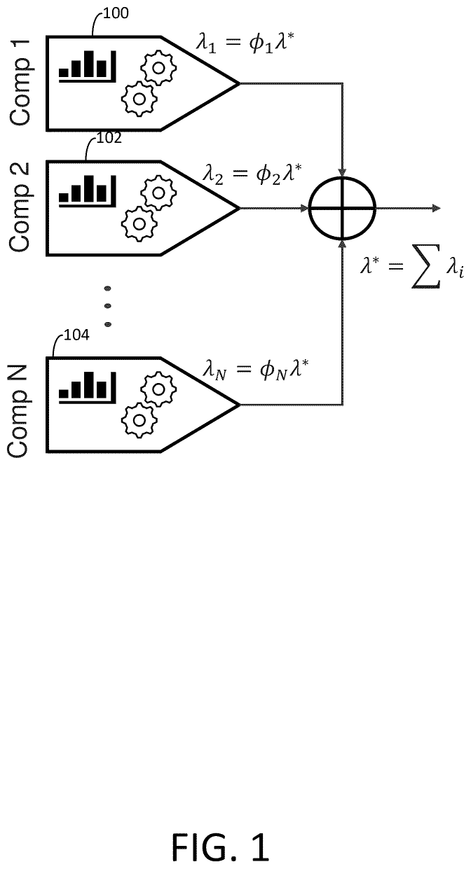

To achieve these and other goals, the subject matter described herein includes a linear model that relates a packet size statistic to a linear combination of packet size statistics generated by a plurality of simulated network traffic generator components. FIG. 1 is a diagram of a plurality of simulated network traffic generator components whose output is combined to produce a desired packet size statistic. A simulated network traffic component is a software instance that can run on a test platform to generate simulated network traffic and send the traffic to a device computing under test. In FIG. 1, three simulated network traffic generator components 100, 102, and 104 are illustrated. However, there can be N simulated network traffic generator components, where N is an integer. Each simulated network traffic generator component 100, 102, and 104 generates an identical application mix of simulated network traffic. For example, each of the components may generate an application mix of simulated network traffic with bandwidth allocations similar to those illustrated in Table 1. Even though each simulated network traffic generator component 100, 102, and 104 is configured to generate identical mixes (by application percentage) of application traffic, the packet sizes generated by each component can be varied by changing open systems interconnect (OSI) layer 3, layer 4, or layer 7 parameters.

One example of a layer 7 parameter that can be used to change average packet size is file size of file uploads or downloads by a simulated application. For example, if a DropBox application is being simulated with a 20% bandwidth allocation by each simulated network traffic generator component, the packet sizes generated by the simulated DropBox applications can be varied by changing the file sizes of the files being uploaded or downloaded by the simulated DropBox applications. Multiple small file uploads or downloads by a simulated DropBox application will result in smaller packets (multiple small packets carrying small file payloads and more acknowledgment packets, which are also small because they also have small payloads) than a large file upload or downloads (packets with larger payloads and fewer acknowledgements). In an example of a layer 4 parameter that can be used to control the average packet size, if the transmission control protocol (TCP) acknowledgement window size is increased, the result will be fewer acknowledgements and a larger average packet size than a simulated application with a smaller TCP acknowledgement window size.

In the example illustrated in FIG. 1, the combination of the packets output from simulated network traffic generator components 100, 102, and 104 produces simulated traffic with a packet size statistic that is linearly related to the percentage of packets produced by each component during a long test times the packet statistic distribution produced by each component during the test. That is, given N simulated network traffic generator components {C₁, C₂, . . . , C_{N}}, where:
Each simulated network traffic generator component Cᵢ produces traffic at a long-term average frame/sec (FPS) λᵢ. The quantity λᵢ is the ratio of number of packets produced by component Cᵢ to the number of packets generated by all of the components during a long run test over the test duration.
Pᵢ=[Pᵢ₁, Pᵢ₂, . . . , Pᵢₛ] is a packet-size distribution vector of size S where 0<pᵢⱼ<1 is the probability (percentage) of packets produced of size j from component i during a long run test. S is the number of packet sizes used to determine the packet size distribution. The probability distribution vector pᵢ for a component Cᵢ can be measured during a measurement phase so that the packet size distribution vector for each component is known.
The component FPS weight 0<ϕᵢ<1 is the percentage of the number of packets produced by i^{th} component to the number of packets generated by all of the components during a long test.

$${ϕ}_{i} {=}^{Δ} \frac{{λ}_{i}}{\sum {λ}_{i}}$$

The test combines traffic from all the components in a first-in-first-out (FIFO) fashion to produce a long-term average FPS λ* =Σλᵢ.
p*=[p*ᵢ, p*₂, . . . , p*ₛ] is the packet-size distribution for the entire test, and the packet size is computable as

$${p}^{*} = \sum {ϕ}_{i} \cdot {p}_{i} = \sum \frac{{λ}_{i}}{{λ}^{*}} \cdot {p}_{i} \qquad ( 1 )$$

As will be explained in more detail below, given the packet size distribution model in Equation 1, a desired value of a packet size statistic, such as a desired average packet size, for a test can be controlled by selecting a plurality of traffic generator components, each configured to generate the same application mix of simulated network traffic and varying the traffic allocations of the components. The components may be configured with different layer 4 or layer 7 parameters such that they will generate different packet sizes for the same application mix of traffic. The components are then allowed to run during a measurement phase, and the packet size probability distribution vector of each component is measured. The desired packet size probability distribution is then used as p* in Equation 1, along with the corresponding packet sizes (see Equation 3 below), and the weights ϕᵢ are solved for, given the known packet size probability distribution vectors p; and the corresponding packet sizes.

A simple example is as follows: suppose the desired average packet size for a test is 300 bytes. Component C₁ is configured with layer 3, layer 4, and layer 7 parameters and is observed, during a measurement phase, to generate packets with an expected size 200 bytes. Component C₂ is configured with layer 3, layer 4 and layer 7 parameters and is observed, during a measurement phase, to generate packets with an expected size of 400bytes. To achieve the desired average packet size of 300 bytes, Equation 3 below can be solved to yield ϕ₁=50% and ϕ₂=50%. Thus, by defining the desired packet size statistic as a linear combination of packet size distributions produced by simulated network traffic generator components, any desired packet statistic can be achieved by adjusting the bandwidth weight assigned to each component, while maintaining the desired application mix of traffic.

### Computing Statistics

We focus on the expectation-type statistics (ETS) that cover (or used to derive) almost all common statistics such as average, variance, histogram graphs, etc. We can show that our proposed multi-component system will provide a linear equation to control any expectation-type packet-size statics of the test by controlling the rate of its components.

Let E(f, p) denote an ETS of packet-size where: p1 p=[P₁, P₂, . . . , >Pₛ] is the vector representing the packet-size probability distribution on the range 1 to S.
f:S→ [symbol] is the feature function mapping each packet size value to a single (K=1) quantity or a vector of K quantities.

$$E ( f , p ) {=}^{Δ} {\sum }_{j = 1}^{s} ( j ) \cdot {p}_{j} \qquad ( 2 )$$

The average packet-size (APS) denoted by μ=E(f(x)=x, p) is the simplest ETS computed as

$$μ = \sum i \cdot {p}_{i}$$

### Controlling the Statistics

The following equation can be used in the computation of an ETS for the test packet size using the measured ETS of its N components:

$$E ( f , {p}^{*} ) {=}^{Δ} {\sum }_{i = 1}^{N} {ϕ}_{i} \cdot E ( f , {p}_{i} ) \qquad ( 3 )$$

Equation (3) is the primary equation that results from combining Equations (1) and (2). Equation 3 indicates that the expected packet size distribution for aggregated network traffic generated by N simulated network traffic generator components is a linear combination of the expected packet size distributions generated by the individual components. Because the expected packet size distributions can be measured during the measurement phase, and the desired value of the packet size statistic is known, Equation 3, or equations derived from Equation 3, can be used to determine the bandwidth weights di need to produce the desired value or distribution of the packet size statistic during a test.

The measured set of components' ETS vectors {E(f,pᵢ)}ᵢ₌₁^{N} form a polyhedral closed space in [symbol] where the ETS of the test can be changed to any desired value within it by setting the component FPS weights {ϕ¹, ϕ₂, . . . , ϕ_{N}}.

In a bandwidth-constrained test, the components' bit rates (throughput) can be set as follows to implicitly enforce the FPS weights calculated above. Let {wᵢ}ᵢ₌₁^{N} denote the set of per component bandwidth weights 0<wᵢ<1 that can be set according to

$${w}_{i} = {ϕ}_{i} \cdot {μ}_{i} ,$$

where μᵢ is the measure average-packet-size of the component i.

### Designing the Components

The number of components (N) depends on the output of dimension of the ETS feature function (K). It can be shown that in most scenarios N≥2K.

Consider the following common ETS and their respective feature functions:

TABLE 2
Controllable Packet Size Statistics

| Statistics (ETS) | Feature Function f(x) | No. Of Components |
|---|---|---|
| Average Packet | f(x) = x | 2 |
| Size (μ) | | |
| Mean/Variance | f(x) = [x, x²] | 4 |
| (μ, σ²) | | |
| Histogram with M | f(x) = [I₁(x), I₂(x), | 2xM |
| Intervals | . . . , I_{M}(x)] | |

In Table 2, the first column is the desired packet size statistic to be generated by the simulated network traffic generator components. The examples in Table 2 include average packet size, mean/variance, and a histogram of packet sizes. The second column is the feature function used to generate the statistic. For example, the feature function used to generate the average packet size is the packet size measurement. The feature function used to generate the mean/variance is the packet size and the square of the packet size. The feature function used to generate the histogram of packet sizes is a bin function in which packet sizes falling within the different interval IM are assigned different values. The third column in Table 2 is the minimum number of simulated network traffic generator components needed to generate each statistic.

The number of components used to generate a desired statistic can be greater than those illustrated in Table 2, for example, to achieve finer grained control and greater variation in packet sizes. One reason for using multiple components to generate a packet size statistic of dimensionality 1, such as average packet size, is so that packet size distribution between the minimum and maximum expected packet sizes produced by the components can be achieved. For example, it may be desirable to generate an application mix of simulated traffic with an expected packet size of 300 bytes from packets with expected sizes that range from 200 bytes to 400 bytes. This goal can be achieved using one simulated network traffic generator component that generates simulated traffic with an expected packet size of 200 bytes and another simulated network traffic generator component of 400 bytes using equal bandwidth allocations assigned to the simulated network traffic generator components.

To meet the objective of maintaining application weights, during the pre-test measurement phase, the components should be configured such that the volume of K-dimensional polyhedral space formed by {E(f, pᵢ)}ᵢ₌₁^{N} is maximized.

### Designing the Components

Given a set of permissible L3/4/7 parameter ranges, the process of designing the simulated network traffic generator components can be automated to maximize the determinant of the cross-covariance matrix (a rough polyhedral size indicator). Only high dimensional statistics, like the distribution (histogram) construction, require an automated iterative algorithm. Designing a few components for simple statistics, like average packet size, is simpler than designing components for higher-dimensionality statistics.

There are several possible iterative algorithms (e.g., Gram-Schmidt) that can be used to efficiently select the component set among many possible candidate sets. A sub-optimal (fast) greedy-algorithm could be:
1. Assign a random combination of L3, L4, and L7 parameters to a component and run the component individually until it reaches steady-state.
2. Estimate its maximum sustainable rate and statistics vector E(f, pᵢ) in the candidate vector set C.
3. Compute ∥ccov(C)∥ and keep the candidate if it has increased this quantity compared to previous iteration, otherwise discard and go back to step 1.

### Controlling Average Packet Size

Average packet size (APS) is the most common packet-size statistic used in evaluating the network device performance. APS links maximum FPS to maximum throughput (Tput). Average packet size depends on L3/L4 configuration and L7 structure. Compared to TCP applications, most user datagram protocol (UDP) applications show less variation in APS, since they have relatively fixed L7 payload structure, and there is not much happening in L4 other than fragmentation. There are a few application protocols (e.g., hypertext transfer protocol (HTTP), simple mail transfer protocol (SMTP)) whose APS can be controlled by their L7 payload when used for file transfer-only. TCP flow control is the main factor in APS variation. TCP flow control responds to the underlying network condition by managing acknowledgement packet and retransmission frequency. The APS can change by a few hundred bytes when downloading the same file from the same HTTPS server under different network conditions. The slower the link, the more frequent Ack/Nack packets, and the lower APS. The following example TCP parameters can be used to control APS:

### Delayed Ack Window

### Maximum Segment Size

### Piggy Backing

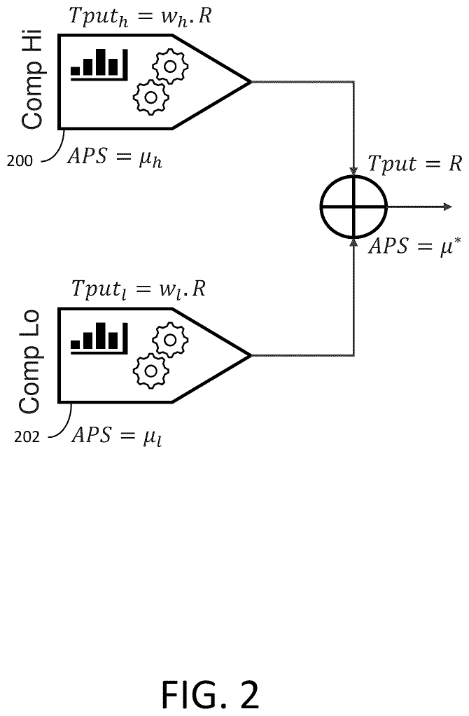

FIG. 2 illustrates an example of controlling average packet size in a two-component system. In FIG. 2, two simulated network traffic generator components 200 and 202 are used to generate an application mix of application traffic with the desired average packet size. Component 200 generates packets with a high expected or average packet size, and component 202 generates packets with a low expected or average packet size. As shown in FIG. 2, the APS can be controlled using only two components, one “high” component and one “low” component, with respective measured APS values μₕ and μ₁. Any desired APS value μₗ<μ*<μₕ can be derived using the components' FPS weights

$${μ}^{*} = {ϕ}_{l} \cdot {μ}_{l} + {ϕ}_{h} \cdot {μ}_{h}$$

or using the component bandwidth weights, (0<wₗ, wₕ<1) as:

$${μ}^{*} = {( \frac{{w}_{h}}{{μ}_{h}} + \frac{{w}_{l}}{{μ}_{l}} )}^{- 1}$$

Given wₕ+wₗ=1, the bandwidth weights are computed as:

$${w}_{h} = \frac{{μ}_{h} \cdot ( {μ}^{*} - {μ}_{l} )}{{μ}^{*} \cdot ( {μ}_{h} - {μ}_{l} )} , {w}_{l} = \frac{{μ}_{l} \cdot ( {μ}_{h} - {μ}^{*} )}{{μ}^{*} \cdot ( {μ}_{h} - {μ}_{l} )}$$

Method steps for designing a two-component system that generates a desired average packet size are as follows:
1. Create a pair of components-one high APS component and one low APS component.
2. Measure APS and throughput for each component.
3. Calculate the new component Tput limits from Equation 3 or Equations 4 and 5 shown below.
4. Enable both components using the calculated Tput limits.

### Creating the High APS Component

As described above, creating a component with a desired APS can be achieved by manipulation of L3, L4, and/or L7 parameters of the simulated network traffic generator components. To extend the APS feasibility range, one or any combination of the techniques below can be used to maximize the APS of the High-APS component:
1. Enabling Delayed Ack
2. Using a High-APS version of any of the simulated applications in the AppMix (if available).
3. Others:
   i. Keeping maximum segment size (MSS) as large as possible
   ii. Enabling piggybacking options
   iii. Removing domain name system (DNS) resolve in non-DNS simulated flows
   iv. Increasing the TCP initial receive window size

### Creating the Low APS Component

To extend the APS feasibility range, one or any combination of the techniques below can be used to minimize the APS of the Low-APS component:
1. Disabling delayed acknowledgements
2. Using a low-APS version of any of simulated applications in the AppMix (if available)
3. Others:
   ii. Disabling piggybacking options
   iii. Keeping DNS resolve in non-DNS simulated flows
   iv. Decreasing the TCP initial receive window size

In one example, a high packet size simulated traffic generator component and a low packet size simulated traffic generator components may be configured to generate an application mix of network traffic with a desired average packet size. During the measurement phase, it is assumed that the low packet size simulated network traffic generator component generates traffic with a throughput of Tputₗₒ=26.565 Gbps and an average packet size of APSₗₒ=641.42 bytes and the high packet size simulated network traffic generator component generates traffic with a throughput of Tputₕᵢ=20.435 Gbps and an average packet size of APSₕᵢ=1170.48 bytes. The total throughput Tputₜₒₜₐₗ=Tputₕᵢ+Tputₗₒ=47 Gbps. If the desired average packet size APS_{desired}=800 bytes, the throughput (bandwidth allocation) for the high and low packet size generator components can be calculated as follows. The target Tput total for the test should be such that both components can reach when enabled simultaneously under any rate limit condition. In most cases, the low-APS component converges to a lower rate than the high-APS component. Thus, we can set Tputₜₒₜₐₗ to the lowest measured component rate in step 2. The following new component Tout limits can be calculated and used to set new throughput values for the components:

$${Tput}_{h i} = \frac{{APS}_{h i} \times ( {APS}_{d e s i r e d} - {APS}_{l o} )}{{APS}_{d e s i r e d} \times ( {APS}_{h i} - {APS}_{l o} )} \times {Tput}_{total} \qquad ( 4 )$$

$${Tput}_{l o} = \frac{{APS}_{l o} \times ( {APS}_{h i} - {APS}_{d e s i r e d} )}{{APS}_{d e s i r e d} \times ( {APS}_{h i} - {APS}_{l o} )} \times {Tput}_{total} , \qquad ( 5 )$$

where Tputₕᵢ is the throughput value calculated for the high simulated network traffic generator component, Tputₗₒ is the throughput value calculated for the low simulated network traffic generator component, APSₕᵢ is an average packet size value of the simulated network traffic generated by the high simulated network traffic generator component, APSI, is the average packet size of the simulated network traffic generated by the low simulated network traffic generator component, APS_{desired} is a desired average packet size value, and Tputₜₒₜₐₗ is a total throughput of the high and low simulated network traffic generator components. Given the values above, the values for Tputₕᵢ and Tputₗₒ using Equations (4) and (5) and the measurements referenced above, the calculated data rate settings for the high and low packet size simulated network traffic generator components are as follows:

Tputₕᵢ₌20.435 Gbps

Tputₗₒ=26.565 Gbps

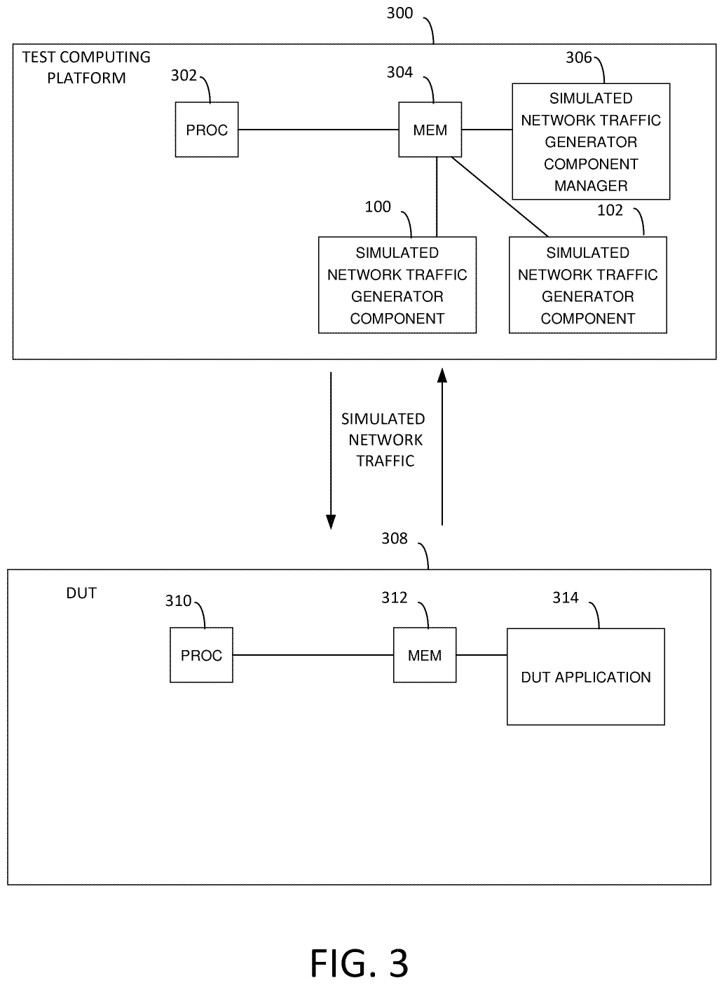

FIG. 3 is a block diagram illustrating an exemplary system for generating an application mix of simulated network traffic with a desired value or distribution of values of a packet size statistic while maintaining network traffic allocations for the applications in the application mix. Referring to

FIG. 3, the system includes a test computing platform 300 including at least one processor 302 and memory 304. Test computing platform 300 further includes a simulated network traffic generator component manager 306 that allows users to create, configure, and control one or more simulated network traffic generator components 100 and 102 to generate an application mix of network traffic that achieves a desired packet size statistic while maintaining traffic allocations to simulated applications. Once configured, simulated network traffic generator components 102 can be enabled to generate and send simulated network traffic to a device under test, such as DUT 308. It should be noted that simulated network traffic generator components 100 and 102 may simulate both ends of a connection for a simulated application. For example, if one of the applications being simulated by simulated network traffic generator components 100 and 102 is a Facebook application, the simulated network traffic generator components 100 and 102 may each simulate the client and server sides of a Facebook transaction to test the performance and or functionality of device under test 308, which may be a router, a firewall, or any other suitable component that receives network traffic. DUT 308 may also include at least one processor 310, memory 312, and a DUT application 314. Simulated network traffic generator components 100 and 102 and simulated network traffic generator component manager 306 may be implemented using computer executable instructions stored in memory 304 and executed by processor 302.

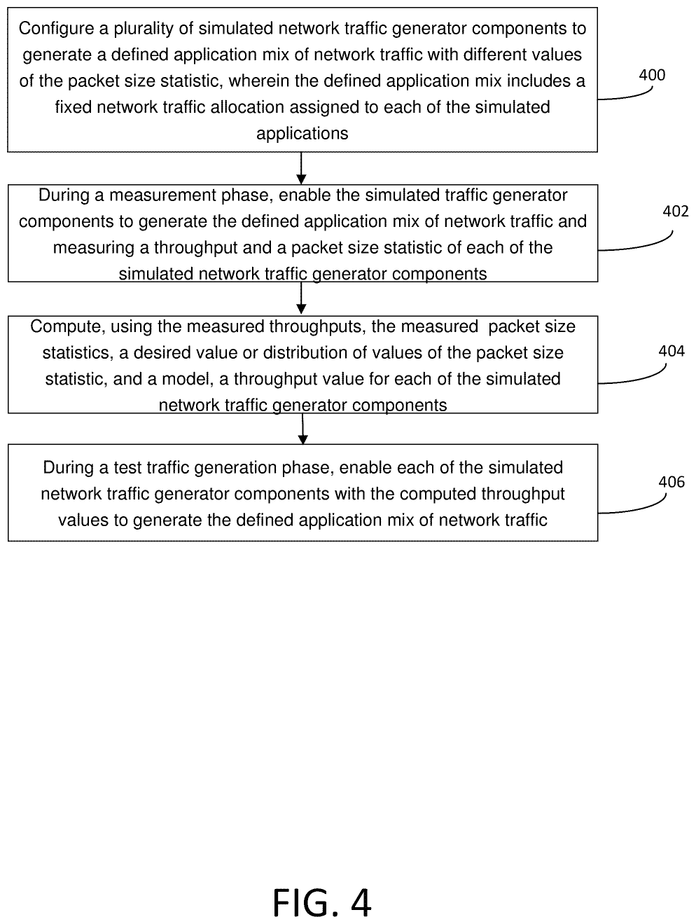

FIG. 4 is a flow chart illustrating an exemplary process for generating an application mix of simulated network traffic with a desired value or distribution of values of a packet size statistic while maintaining network traffic allocations for the applications in the application mix. Referring to FIG. 4, in step 400, the process includes configuring a plurality of simulated network traffic generator components to generate a defined application mix of network traffic with different values of the packet size statistic, wherein the defined application mix includes fixed network traffic allocations assigned to each of a plurality of simulated applications. For example, simulated network traffic generator component manager 306 may allow a user to configure simulated network traffic generator components to generate the same mix of application traffic, an example of which is illustrated in Table 1 above. Simulated network traffic generator component manager 306 may also allow the user to set layer 3, layer 4, and layer 7 parameters for each of the simulated network traffic generator components so that the simulated network traffic generator components have packet size distributions that are different from each other.

In step 402, the process further includes during a measurement phase, enabling the simulated network traffic generator components to generate the defined application mix of network traffic and measuring a throughput and a packet size statistic of each of the simulated network traffic generator components. For example, simulated network traffic generator component manager 306 may allow a user to enable the configured simulated network traffic generator components to start generating and sending network traffic. Simulated network traffic generator component manager 306 may measure the packet size distribution and the throughput of each component during the measurement phase.

In step 404, the process includes computing, using the measured throughputs, the measured packet size statistics, a desired value or distribution of values of the packet size statistic, and a model, a throughput value for each of the simulated network traffic generator components. For example, simulated network traffic generator component manager 306 may allow a user to input a desired value of a packet size statistic, such as average packet size and may use Equation 3 or an equation derived from Equation 3 (e.g., Equations 4 and 5), to determine throughputs to assign to each component so that the combined or aggregated output rom the network traffic generator components will have the desired value or distribution of the packet size statistic.

In step 406, the process further includes, during a test traffic generation phase, enabling each of the simulated network traffic generator components with the computed throughput values to generate the defined application mix of network traffic. When enabled with the throughput values computed using the model, the simulated network traffic generated by the components, when aggregated, results in a value or distribution of values of the packet size statistic that is equal to or nearly equal to the desired value or distribution of values of the packet size statistic while maintaining the network traffic allocations assigned to the simulated applications.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for generating an application mix of simulated network traffic with a desired packet size statistic while maintaining traffic allocations in the application mix, the method comprising:
configuring a plurality of simulated network traffic generator components to generate a defined application mix of network traffic with different values of the packet size statistic, wherein the defined application mix includes a fixed network traffic allocation assigned to each of a plurality of simulated applications;
during a measurement phase, enabling the simulated network traffic generator components to generate the defined application mix of network traffic and measuring a throughput and a packet size statistic of each of the simulated network traffic generator components;
computing, using the measured throughputs, the measured packet size statistics, a desired value or distribution of values of the packet size statistic, and a model, a throughput value for each of the simulated network traffic generator components; and
during a test traffic generation phase, enabling each of the simulated network traffic generator components with the computed throughput values to generate the defined application mix of network traffic.

2. The method of claim 1 wherein configuring the simulated network traffic generator components to generate the application mix of simulated network traffic includes configuring the simulated network traffic generator components with the same fixed network traffic allocation values for the same applications simulated by different ones of the simulated network traffic generator components.

3. The method of claim 1 wherein configuring the simulated network traffic generator components to generate the defined application mix of network traffic with different values of the packet size statistic includes configuring open systems interconnect (OSI) layer 3, layer 4, and/or layer 7 parameters of the simulated network traffic generator components to generate the different values of the packet size statistic.

4. The method of claim 3 wherein the packet size statistic comprises an average packet size and wherein configuring the simulated network traffic generator components to generate the different values of the packet size statistic includes configuring a first simulated network traffic generator component to generate simulated network traffic with a first average packet size value and configuring a second simulated network traffic generator component to generate simulated network traffic with a second average packet size value, wherein the first average packet size value is greater than the second average packet size value.

5. The method of claim 4 wherein computing the throughput values comprises computing:
$${Tput}_{h i} = \frac{{APS}_{h i} \times ( {APS}_{d e s i r e d} - {APS}_{l o} )}{{APS}_{d e s i r e d} \times ( {APS}_{h i} - {APS}_{l o} )} \times {Tput}_{total}$$
$${Tput}_{l o} = \frac{{APS}_{l o} \times ( {APS}_{h i} - {APS}_{d e s i r e d} )}{{APS}_{d e s i r e d} \times ( {APS}_{h i} - {APS}_{l o} )} \times {Tput}_{total} ,$$
where Tputₕᵢ is the throughput value calculated for the first simulated network traffic generator component, Tputₗₒ is the throughput value calculated for the second simulated network traffic generator component, APSₕᵢ is an average packet size value of the simulated network traffic generated by the first simulated network traffic generator component, APSₗₒ is the average packet size of the simulated network traffic generated by the second simulated network traffic generator component, APS_{desired} is a desired average packet size value, and Tputₜₒₜₐₗ is a total throughput of the first and second simulated network traffic generator components.

6. The method of claim 1 wherein the packet size statistic is variance in packet size values.

7. The method of claim 1 wherein the packet size statistic is a desired distribution of packet size values.

8. The method of claim 1 wherein the model relates the desired packet size statistic value or distribution of values to a linear combination of values or distributions of values of the packet size statistic for simulated network traffic generated by the simulated network traffic generator components.

9. The method of claim 8 wherein the model is defined by the following expression:
$$E ( f , {p}^{*} ) {=}^{Δ} {\sum }_{i = 1}^{N} {ϕ}_{i} \cdot E ( f , {p}_{i} ) ,$$
where E(f, p*) is an expected value of the packet size statistic for simulated network traffic generated by all of the simulated network traffic generator components, f is a feature function that produces the values of the packet size statistic, p′ is probability distribution of values of the packet size statistic for the simulated network traffic generated by all of the simulated network traffic generator components, ϕᵢ is a network traffic weight assigned to an i^{th} simulated network traffic generator component, E(f, pᵢ) is an expected value of the packet size statistic for the i^{th} simulated network traffic generator component, and pᵢ is a probability distribution for values of the packet size statistic for the i^{th} simulated network traffic generator component.

10. The method of claim 1 wherein the defined application mix of network traffic generated during the test traffic generation phase achieves a value or distribution of values of the packet size statistic that is equal to or substantially equal to the desired value or distribution of values of the packet size statistic while maintaining the fixed network traffic allocations assigned to the simulated applications.

11. A system for generating an application mix of simulated network traffic with a desired packet size statistic while maintaining traffic allocations in the application mix, the system comprising:
a test computing platform including at least one processor and a memory; and
a simulated network traffic generator component manager executable by the at least one processor for:
configuring a plurality of simulated network traffic generator components to generate a defined application mix of network traffic with different values of the packet size statistic, wherein the defined application mix includes a fixed network traffic allocation assigned to each of a plurality of simulated applications;
during a measurement phase, enabling the simulated network traffic generator components to generate the defined application mix of network traffic and measuring a throughput and a packet size statistic of each of the simulated network traffic generator components;
computing, using the measured throughputs, the measured packet size statistics, a desired value or distribution of values of the packet size statistic, and a model, a throughput value for each of the simulated network traffic generator components; and
during a test traffic generation phase, enabling each of the simulated network traffic generator components with the computed throughput values to generate the defined application mix of network traffic.

12. The system of claim 11 wherein the simulated network traffic generator component manager configures the simulated network traffic generator components with the same fixed network traffic allocation values for the same applications simulated by different ones of the simulated network traffic generator components.

13. The system of claim 11 wherein the simulated network traffic generator component manager configures the simulated network traffic generator components to achieve the different values of the packet size statistic by configuring open systems interconnect (OSI) layer 3, layer 4, and/or layer 7 parameters of the simulated network traffic generator components to generate the different values of the packet size statistic.

14. The system of claim 13 wherein the packet size statistic comprises an average packet size and the simulated network traffic generator component manager configures a first simulated network traffic generator component to generate simulated network traffic with a first average packet size value and a second simulated network traffic generator component to generate simulated network traffic with a second average packet size value, wherein the first average packet size value is greater than the second average packet size value.

15. The system of claim 14 wherein the simulated network traffic generator component manager is configured to compute the throughput values as follows:
$${Tput}_{h i} = \frac{{APS}_{h i} \times ( {APS}_{d e s i r e d} - {APS}_{l o} )}{{APS}_{d e s i r e d} \times ( {APS}_{h i} - {APS}_{l o} )} \times {Tput}_{total}$$
$${Tput}_{l o} = \frac{{APS}_{l o} \times ( {APS}_{h i} - {APS}_{d e s i r e d} )}{{APS}_{d e s i r e d} \times ( {APS}_{h i} - {APS}_{l o} )} \times {Tput}_{total} ,$$
where Tputₕᵢ is the throughput value calculated for the first simulated network traffic generator component, Tputₗₒ is the throughput value calculated for the second simulated network traffic generator component, APSₕᵢ is an average packet size value of the simulated network traffic generated by the first simulated network traffic generator component, APSₗₒ is the average packet size of the simulated network traffic generated by the second simulated network traffic generator component, APS_{desired} is a desired average packet size value, and Tputₜₒₜₐₗ is a total throughput of the first and second simulated network traffic generator components.

16. The system of claim 11 wherein the packet size statistic is variance in packet size values.

17. The system of claim 11 wherein the packet size statistic is a desired distribution of packet size values.

18. The system of claim 11 wherein the model the model relates the desired packet size statistic value or distribution of values to a linear combination of values or distributions of values of the packet size statistic for simulated network traffic generated by the simulated network traffic generator components.

19. The system of claim 18 wherein the model is defined by the following expression:
$$E ( f , {p}^{*} ) {=}^{Δ} {\sum }_{i = 1}^{N} {ϕ}_{i} \cdot E ( f , {p}_{i} ) ,$$
where E(f, p*) is an expected value of the packet size statistic for simulated network traffic generated by all of the simulated network traffic generator components, f is a feature function that produces the values of the packet size statistic, ρ* is probability distribution of values of the packet size statistic for the simulated network traffic generated by all of the simulated network traffic generator components, ϕᵢ is a network traffic weight assigned to an i^{th} simulated network traffic generator component, E(f, pᵢ) is an expected value of the packet size statistic for the i^{th} simulated network traffic generator component, and pᵢ is a probability distribution for values of the packet size statistic for the i^{th} simulated network traffic generator component.

20. A non-transitory computer readable medium having stored thereon executable instructions that when executed by a processor of a computer control the computer to perform steps comprising:
configuring a plurality of simulated network traffic generator components to generate a defined application mix of network traffic with different values of a packet size statistic, wherein the defined application mix includes a fixed network traffic allocation assigned to each of a plurality of simulated applications;
during a measurement phase, enabling the simulated network traffic generator components to generate the defined application mix of network traffic and measuring a throughput and a packet size statistic of each of the simulated network traffic generator components;
computing, using the measured throughputs, the measured packet size statistics, a desired value or distribution of values of the packet size statistic, and a model, a throughput value for each of the simulated network traffic generator components; and
during a test traffic generation phase, enabling each of the simulated network traffic generator components with the computed throughput values to generate the defined application mix of network traffic.
